(19) United States
(12) Patent Application Publication
(10) Pub. No.: US 2002/0129835 A1
(43) Pub. Date: Sep. 19, 2002

(54) Motorized hand-held scrubbing device, a disposable scrubbing surface, and a method of use therefor

(75) Inventors: Lucio Pieroni, (US); Peter Robert Foley, (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gambie Company

(21) Appl. No.: 10/027,647

(22) Filed: Dec. 21, 2001

Related U.S. Application Data
(60) Provisional application No. 60/257,841, filed on Dec. 21, 2000.

(51) Int. Cl. A46B 13/04; B08B 1/04

(52) U.S. Cl. 134/6; 15/97.1; 15/29; 15/104.94

(57) ABSTRACT

A hand-held scrubbing device for cleaning a surface has a waterproof casing having an interior area and an exterior area. The interior area has an electromechanical motor and a battery joined to the electromechanical motor. The exterior area has a scrubbing surface removably joined to the electromechanical motor which provides a mechanical action to the scrubbing surface. The scrubbing surface is impregnated with a cleaning composition. A kit has a hand-held scrubbing device, while a method of use employs such a hand-held scrubbing device. A disposable scrubbing surface impregnated with a cleaning composition is designed for use with a hand-held scrubbing device.

### FIELD OF THE INVENTION

The present invention relates to a hand-held scrubbing device, a disposable scrubbing surface, and a method of use therefor. Specifically, the present invention relates to a hand-held scrubbing device which contains an electromechanical motor, a disposable scrubbing surface, and a method of use therefor.

### BACKGROUND OF THE INVENTION

Cleaning a surface, such as a hard surface, may often require intense scrubbing, especially in cases where the item to be cleaned has dirt, oils, and/or grime encrusted thereupon. Furthermore, this scrubbing is typically very tedious and labor-intensive, especially where there are multiple surfaces and/or a large surface to be cleaned. Such scrubbing may also take a long time, and may thus be excessively burdensome.

In particular cases, such as where the food is encrusted and/or baked onto dishes, pots, pans, etc., it may be desirable to apply a cleaning composition, for example, a liquid dishwashing composition, to the dish in order to clean it. Thus, one typically applies a cleaning composition to a scrubbing pad, sponge, steel wool or other substrate and then vigorously scrubs the dish. However, even when a scrubbing pad is used, intensive scrubbing, and therefore significant manual labor, may be required before the dish is cleaned to the person's satisfaction. This manual cleaning is both exhausting, and extremely time-consuming.

While mechanical and electrical devices are known for industrial or manual labor applications, such as sanding, polishing, buffing, etc., these devices are very heavy and are not suitable for cleaning relatively delicate items, such as dishes or household hard surfaces. In addition, such devices are typically intended for heavy manual applications, and may be very noisy, and/or deliver significant, and even uncomfortable levels of vibrations to the user. Thus, these devices are unsuitable for extended, everyday use.

Accordingly, the need exists for an improved device and kit for household cleaning. The need also exists for a scrubbing surface useful with such an improved device. The need also exists for an improved method for cleaning, which employs such an improved device.

### SUMMARY OF THE INVENTION

The present invention relates to a hand-held scrubbing device for cleaning a surface which has a waterproof casing having an interior area and an exterior area. The interior area has an electromechanical motor and a battery joined to the electromechanical motor. The exterior area has a scrubbing surface removably joined to the electromechanical motor which provides a mechanical action to the scrubbing surface. The scrubbing surface is impregnated with a cleaning composition. A kit containing such a hand-held scrubbing device, and a method of use therefor are also provided herein. A disposable scrubbing surface impregnated with a cleaning composition is also provided, for use with a handheld scrubbing device.

It has now been found that a hand-held scrubbing device may provide significant mechanical action so as to clean an item, while still being light enough for extended use, especially by elderly people. By employing a removable scrubbing surface, the present invention may also provide improved sanitation, especially when disposable scrubbing surfaces are employed, which may lead to improved health benefits. The hand-held scrubbing device herein also reduces the need for a consumer to add a cleaning composition to a scrubbing pad, as a cleaning composition is already impregnated therein. In addition, the hand-held scrubbing device may reduce consumer's hand contact with the cleaning solution, and the time spent to clean the item. This provides the user with more free time, and may also minimize the potential for skin irritation.

Such a hand-held scrubbing device may be easy to hold, comfortable to use, and yet may be used on relatively delicate items such as dishes, plates, or even glassware. The hand-held scrubbing device may also provide acceptable cleaning, while reducing the transfer of annoying vibrations to the user, so as to provide an improved method for cleaning an item, and especially dishware. Furthermore, the present invention may reduce the need for pre-soaking tough and/or hardened stains and may make it easier to remove encrusted soils.

These and other features, aspects, advantages, and variations of the present invention, and the embodiments described herein, will become evident to those skilled in the art from a reading of the present disclosure with the appended claims, and are covered within the scope of these claims.

### BRIEF DESCRIPTION OF THE FIGURES

While the specification concludes with claims particularly pointing out and distinctly claiming the invention, it is believed that the invention will be better understood from the following description of the accompanying figures in which:

FIG. 1 is an exterior side view of a preferred embodiment of a hand-held scrubbing device; and

FIG. 2 is a cut-away side view of a preferred embodiment of a hand-held scrubbing device.

### DETAILED DESCRIPTION OF THE INVENTION

All percentages, ratios and proportions herein are by weight, unless otherwise specified. All temperatures are in degrees Celsius (° C.) unless otherwise specified. All documents cited are incorporated herein by reference in their entireties. Citation of any reference is not an admission regarding any determination as to its availability as prior art to the claimed invention. The figures herein are not necessarily drawn to scale.

As used herein, the term “hand-held” describes an item, at least one part of which is easily and conveniently handled in an average-sized human hand. Preferably, this term indicates that the entire item has an ergonomic size, weight, and shape which makes it easy to comfortably hold in the hand, during use.

As used herein, the term “waterproof” indicates that unless opened, broken, cracked, etc., the item is substantially impervious to water inadvertently entering the interior area of the item, during normal use. This term does not encompass any water which is specifically added, or desirably added into the interior of the item.

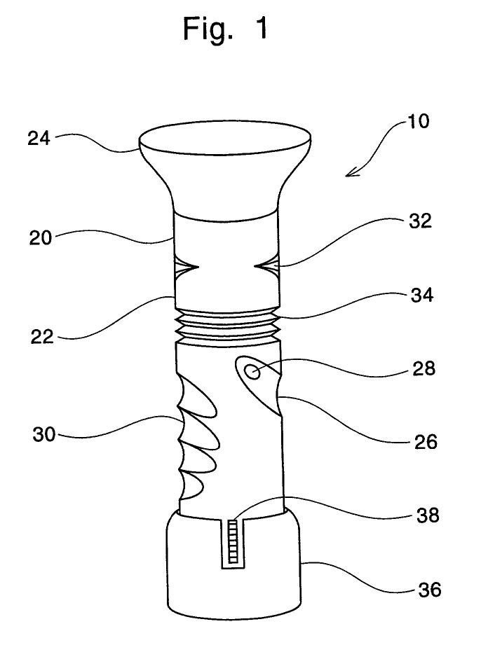

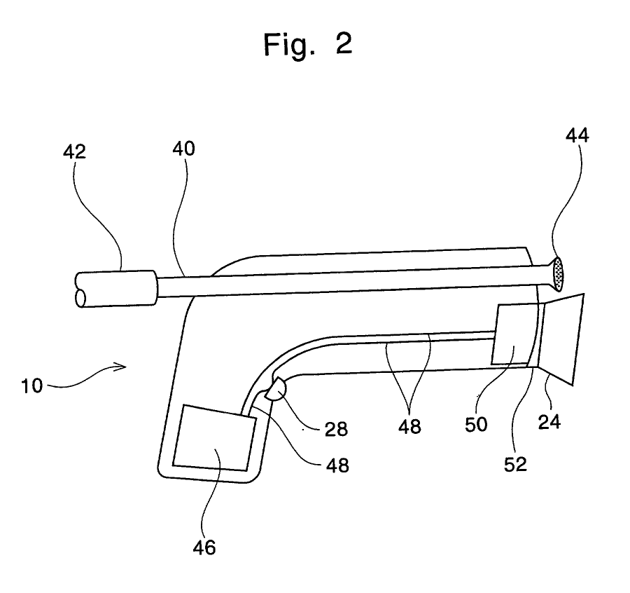

Referring to the figures, FIG. 1 shows an exterior side view of a preferred embodiment of the hand-held scrubbing device (HHSD) of the present invention. In FIG. 1, the HHSD, 10, has a waterproof casing, 20, which contains an exterior area, 22. The exterior area, 22, also contains a scrubbing surface, 24, which is removably joined to an electromechanical motor (see FIG. 2 at 50), via a heating element (see FIG. 2 at 52). The exterior area, 22, also contains a thumb grip, 26, which contains a motor activator, 28. The thumb grip, 26, combines with an ergonomic grip, 30, to reduce slippage. The exterior area, 22, also contains a vibration buffer, 32, distal from the ergonomic grip, 30, and a pivoting portion, 34, therebetween.

The casing useful herein may be formed of any material, especially plastic, resin, and/or a polymer, and is waterproof, so as to prevent water and/or cleaning solution from contacting and damaging the components contained therein. Furthermore, the waterproof casing herein may be formed in a variety of colors, designs, etc., so as to appeal to various kitchen decorating styles. In a preferred embodiment, the waterproof casing of the HHSD has interchangeable color panels which users may employ to customize the HHSD according to their own tastes.

For ease of use, the HHSD and/or the waterproof casing is preferably designed to float when dropped into water. The size, shape, weight, balance, and other physical characteristics of the waterproof casing and/or the exterior area may vary without departing from the scope of the present invention. The size of the HHSD may vary considerably depending upon the desired shape, but at least a portion of the HHSD should be of a size and shape which is ergonomically-designed; i.e., convenient and comfortable to hold in the hand. Preferably, the HHSD is from about 3 cm to about 50 cm, and more preferably from about 5 cm to about 30 cm in length, while the height and width of the HHSD are each independently from about 0.5 cm to about 20 cm, and more preferably from about 1 cm to about 15 cm. However, these measurements are not intended to be in any way limiting to the present invention, as long as the HHSD is able to be easily and comfortably held in the average human hand. Thus, the HHSD is preferably be designed to have a generally wand-like shape, a pistol-like shape, an ergonomically-contoured shape, and a combination thereof. Furthermore, the HHSD may be ergonomically-designed to be used in the left hand, the right hand, or both, as desired. Accordingly, a thumb grip and/or ergonomic grip to reduce slippage is highly preferred. While the HHSD of FIG. 1 is intended to be held like a flashlight in the right hand, other embodiments and designs are also included herein.

For ease of use and ease of holding, it is preferred that the HHSD weigh from about 1 g and about 1 kg, preferably from about 10 g to about 500 g, and more preferably from about 20 g to about 400 g. Without intending to be limited by theory, it is believed that a HHSD outside the above ranges may be either 1) too heavy for the average person to use either repeatedly, and/or for an extended period of time, or 2) may not possess sufficient cleaning composition capacity, and/or battery life to be useful for an extended period of time.

The scrubbing surface useful herein is preferably formed of a sponge, a brush, a woven material, a nonwoven material, an abrasive material, a plastic material, a cloth material, a polymeric material, a resin material, a rubber material, or a mixture thereof, preferably a brush, an abrasive material, a foam rubber material, a functional absorbent material (FAM), a polyurethane foam, and a mixture thereof. If the scrubbing surface is formed from a relatively delicate material, or a material which is easily torn, then it is preferable that this material be covered, partially or completely, with a water-permeable, more robust material, such as a nonwoven material.

Preferably, the FAM useful herein has an absorbent ability of more than about 20 g H₂O/g, more preferably, 40 g H₂O/g by weight of FAM. Such a preferred FAM is described in U.S. Pat. No. 5,260,345 to DesMarais, et al., issued on Nov. 9, 1993 or U.S. Pat. No. 5,889,893 to Dyer, et al., issued on May 4, 1999. Examples of a preferred polyurethane is described in U.S. Pat. No. 5,089,534 to Thoen, et al., issued on Feb. 18, 1992; U.S. Pat. No. 4,789,690 to Milovanovic-Lerik, et al., issued on Dec. 6, 1988; Japanese Patent Publication No. 10-182780 to Kao Corporation, published on Jul. 7, 1998; Japanese Patent Publication No. 9-30215 to Yokohama Gum, published on Feb. 4, 1997; Japanese Patent Publication No. 5-70544 to The Dow Chemical Company, published on Mar. 23, 1993; and Japanese Patent Publication No. 10-176073 to The Bridgestone Company, published on Jun. 30, 1998.

Preferably, the scrubbing surface is not hard, but instead has at least one resilient portion, preferably resilient portion which is covered by an abrasive portion. Such an optional resilient portion allows the user to vary the amount of contact, pressure, etc., between the scrubbing surface and the item to be cleaned, for example, a dish or glassware. The scrubbing surface is also preferably a porous scrubbing surface with an open-celled structure to enhance cleaning and the passage of water and cleaning composition through the scrubbing surface. Such a porous scrubbing surface may also promote desirable lathering characteristics when used with a cleaning composition.

The scrubbing surface is removably joined to the electromechanical motor, which means that the scrubbing surface may be easily removed, replaced, and/or exchanged, as desired. However, the scrubbing surface is sufficiently affixed to the electromechanical motor, either directly or indirectly, such that it is not likely to unexpectedly detach during actual use of the HHSD. The detachable scrubbing surface herein may employ any convenient attachment system, such as a locking mechanism, a waterproof or water resistant adhesive, a mechanical clamp, a plastic or flexible attachment system (e.g., matching VELCROTM strips), etc.

A plurality of scrubbing surfaces may be provided, each of which has particular cleaning characteristics, such as a predetermined resiliency, a special shape, a special cleaning chemistry, etc. The scrubbing surface useful herein may be shaped in virtually any shape, as desired, but is preferably designed with the item to be cleaned, in mind. For example, a scrubbing surface designed for cleaning a flat plate should have at least one large, flat side for contacting the flat plate, whereas a scrubbing surface for cleaning a champagne flute should be elongated and thinner. In addition, the hardness/softness and texture of the scrubbing surface may also be varied; a soft scrubbing surface may be provided for cleaning delicate materials such as bone china, a soft and elongated scrubbing surface may be provided for cleaning crystalware, a hard and abrasive scrubbing surface may be provided for cleaning pots and pans, etc. Each of these scrubbing surfaces may be detachably fixed to the HHSD, and exchanged as appropriate. In addition, a detachable scrubbing surface has the advantages of being easily replaced when worn out, when the cleaning composition impregnated therein is used up, for sanitation purposes, etc. Furthermore, the detachable scrubbing surface may contain various chemistries impregnated on separate scrubbing surfaces, impregnated on the same scrubbing surface, impregnated in different physical locations on the same scrubbing surface, etc. This is especially useful for chemistries which may be incompatible with each other if provided in a single composition, for example, bleaches, enzymes, pH buffers, etc. If separate scrubbing surfaces are provided, each may be directed to a specific type of cleaning; for example, oil/fat dispersants, abrasives, etc. Such a design may also allow a user to employ sequential chemistries to an item to be cleaned, so as to provide optimum results.

The scrubbing surface herein may therefore contain a number of active ingredients impregnated thereupon, including an enzyme, a bleach, a surfactant, a builder, a biocide, a perfume, a polymer, a moisturizer, an alkalinity source, a pH buffer, a rinse aid, a solvent, and a mixture thereof. These may in turn be optionally formulated with a controlled release technology so as to enhance stability, or to deliver consistent active delivery during use. Preferably, the scrubbing surface is impregnated with a controlled release technology selected from the group consisting of an emulsion polymer, a zeolite, a cyclodextrin, a starch encapsulate, a multi-layered thin film polymer, and a combination thereof.

Thus, the scrubbing surface is impregnated with a cleaning composition which may be any consumer product composition which is intended to be directly or indirectly (e.g., by dispersing in water) applied to an item to be cleaned. The item to be cleaned is usually subjected to a scrubbing action, either during, or after application of the cleaning composition. Typically, the cleaning composition herein will be a hard surface cleaning composition, although other types of cleaning compositions may be useful herein as well. Without intending to be limited by theory, it is believed that a hard surface cleaning composition may especially benefit from the HHSD, kit and method herein, as they are commonly used in a hand-washing situation, and in a situation where extended scrubbing is required. The cleaning composition herein is typically soluble, preferably highly soluble, in water.

While the physical properties of the cleaning composition should be considered when designing the scrubbing surface, the cleaning composition useful herein is not limited in physical form, and may be aqueous or non-aqueous, and may be in a liquid, solid, paste, foam, granule, gel, or any other consumer-acceptable form, as long as it may be impregnated in the scrubbing surface, and released therefrom for use to clean an item. The scrubbing surface may be impregnated with the cleaning composition by a variety of methods, such as by spraying the cleaning composition onto the scrubbing surface, by immersing the scrubbing surface in the cleaning composition, by forming the scrubbing surface around the cleaning composition, by injecting the cleaning composition into the scrubbing surface, etc. Typically, the cleaning composition will be released by contacting the scrubbing surface with water, although other methods, such as heat-activation, are also possible, and included herein.

The cleaning composition useful herein may include a variety of ingredients known in the art, for example, a surfactant, a solvent, water, a soil release agent or soil release polymer, a perfume, a dye, a bleach, an enzyme, a malodor absorbing agent (e.g., cyclodextrin), etc.

The hard surface cleaning composition useful herein is typically formulated for use on a surface and/or an item such as a dish, tiling, flooring, a wall, glass, etc. Preferably, the hard surface cleaning composition is a hand dishwashing composition, a floor cleaning composition, and/or a glass cleaning composition.

Preferred examples of such a hard surface cleaning composition include aqueous and non-aqueous cleaning compositions such as described in, for example, U.S. Patent. No. 5,990,065 to Vinson, et al., issued on Nov. 23, 1999; WO 99/03512 A1 to Boucher and Kain, published on Jan. 28, 1999; WO 99/24539 A1 to Kasturi, et al., published May 20, 1999; WO 99/27058 A1 to Kasturi, et al., published Jun. 3, 1999; WO 99/27054 to Kasturi and Schafer, published on Jun. 3, 1999; WO 99/27053 to Kasturi, et al., published on Jun. 3, 1999; WO 99/27057 to Kasturi, et al., published on Jun. 3, 1999; WO 99/63034 to Vinson, et al., published on Dec. 9, 1999; WO 00/46331 to Clarke, et al., published Aug. 10, 2000; and EP Application No. 99/870275.7 by Clarke, et al., filed on Dec. 22, 1999.

A highly preferred cleaning composition useful herein also contains a bleach, such as a chlorine bleach, an oxygen bleach, or a mixture thereof; and more preferably a pre-formed peracid bleach, such as e-phthalimido-peroxyhexanoic acid, available as EURECO® from Ausimont USA, Inc. (Thorofare, N.J., USA; see also http://www.ausiusa.com). If present, the bleach, and preferably the pre-formed peracid bleach, will typically be present at a level of from about 2% to about 20% by weight of the cleaning composition, although higher and lower levels are also useful herein. To improve stability, a pre-formed peracid bleach may be contained within a composition having a pH of less than about 7. Then, upon activation, the pre-formed peracid bleach may release the peracid, which in turn generates active oxygen which bleaches the item to be cleaned.

Furthermore, it is highly preferred that the cleaning composition have a pH of more than about 7, more preferably more than about 11, during use, as an alkaline environment may significantly help to loosen and dissolve certain soils. Such a pH during use may be provided by employing pH buffers and/or other methods known in the art.

In FIG. 1, the optional vibration buffer, 32, serves to reduce the amount and/or intensity of the vibrations transmitted to the user and/or to the surrounding environment. This may significantly enhance the amount of time which the HHSD can be comfortably used and may significantly also reduce the noise level of the HHSD, during use. Such a vibration buffer is thus highly desirable. The vibration buffer useful herein may be designed by, for example, providing a foam rubber buffer in the interior area and/or the exterior area, by incorporating one or more soft plastic or rubber gaskets into the HHSD, etc. In a preferred embodiment, the HHSD provides less than about 85 decibels (dB) of noise, preferably from about 0 dB to about 75 dB of noise, and more preferably from about 35 dB to about 70 dB of noise during use, as compared to a typical ambient background noise level of about 50 dB to 55 dB. Noise level can be controlled either via the use of low noise electrical engines, or via the incorporation of noise buffers into the design of the HHSD. A noise buffer may be provided by, for example, using rubber or plastic-dampened motor mountings, and/or a layered case design with light weight insulation or air incorporated in between the layers. The latter may also serve to increase the ‘floatability’ of the HHSD.

It is also preferred that the electromechanical motor provide an acceptable noise character during use. For example, a high-pitched whine such as found in a dentist's drill is typically unacceptable to a typical consumer. Accordingly, the noise character of the HHSD during use, charging, etc. should be such that the peak frequency is less than about 3 kHz, preferably less than 1.5 kHz. Even more preferably, both the noise level and the noise character are considered when designing the HHSD, such that both are acceptable to the consumer.

In FIG. 1, the optional pivoting portion, 34, is joined to the scrubbing surface, 24, and allows the user to easily direct the scrubbing surface, 24, to a specific portion of the item to be cleaned, and to follow the contours of the item, by changing the relative angle between the scrubbing surface and the ergonomic grip.

In FIG. 1, the motor activator, 28, is a pressure-sensitive button which is joined to and which activates the electromechanical motor (FIG. 2 at 50) which in turn provides a mechanical action to the scrubbing surface, 24. The motor activator on the exterior area of the HHSD is optional, as it may also be in the internal area of the waterproof casing. For example, the HHSD's electromechanical motor may be designed to “automatically” turn on and off when aligned to a certain angle for use, and/or when removed from a recharging stand. In FIG. 1, the motor activator, 28, is designed to be easily and comfortably pressed during use. The motor activator useful herein may be designed as a button, a switch, a dial, etc., and may activate the electromechanical motor only while being activated (e.g., depressed), until activated a second time, etc. In a preferred embodiment, the motor activator is a variable-speed motor activator, where the harder the motor activator is depressed, the farther the motor activator is turned, etc., then the faster is the mechanical action provided by the electromechanical motor.

The HHSD, 10, of FIG. 1 is resting in an induction-type recharging stand, 36. The HHSD also has a built-in charge indicator, 38, which indicates the approximate percent of charge remaining in the rechargeable battery (see FIG. 2 at 46). In cases where the battery is a rechargeable battery, it is highly preferred that the recharging mechanism be an induction-type recharging mechanism, typically with a convenient recharging stand, as these do not require external contacts in order to recharge the battery. Such a recharging system, which is commonly used in rechargeable cordless phones and razors, is especially preferred as it avoids corrosion of external (i.e., exposed on the exterior area of the waterproof casing) recharging contacts, and potential short-circuiting caused by electricity undesirably flowing between external recharging contacts. Typically, at least a part of the HHSD rests in the recharging stand, although the entire HHSD may also rest therein.

The charge indicator useful herein may be any type of charge indicator known in the art, such as are used for rechargeable razors, flashlights, etc. Preferred embodiments of the charge indicator herein include one or more light emitting diodes, a meter, a color indicator, a liquid crystal display, a light, etc. In an alternative, yet preferred embodiment, the charge indicator is located on the recharging stand.

FIG. 2 shows a cut-away side view of a preferred embodiment of a HHSD. In FIG. 2, the HHSD, 10, has a water connection, 40, which is connected to a water hose, 42. The water hose, 58, in turn, is connected to a faucet (not shown) or the like. The water connection, 40, terminates in a rinsing orifice, 44, which is used to wet and/or rinse off the item to be cleaned. The HHSD, 10, also contains a battery, 46, which is connected, via a series of wires, 48, to a motor activator, 28, and an electromechanical motor, 50. The electromechanical motor, 50, in turn, is directly joined to the scrubbing surface, 24. When the motor activator, 28, is depressed, it completes the circuit, and activates the electromechanical motor, 50. The electromechanical motor, 50, then produces a mechanical action which is transferred to the scrubbing surface, 24. The scrubbing surface is then contacted to an item to clean it.

The water connection useful herein may be a tube which merely connects the water hose to the rinsing orifice, or may further include a regulation mechanism for controlling the water pressure, water flow, etc. The regulation mechanism may include, for example, an external trigger or activator, a valve, a pressure regulator, a filter, etc., as desired. Alternatively, water flow may be controlled, by, for example, turning on and off the faucet.

The rinsing orifice may be designed to provide any type of water spray, as desired, ranging from a gentle shower, to a strong, directed stream. Preferably, the rinsing orifice is adjustable to provide a variety of water sprays which are selectable by the user.

The battery useful herein may be any disposable, and/or rechargeable battery or other power source known in the art, preferably an alkaline battery, a nickel-cadmium battery, a nickel-metal hydride battery, a zinc-carbon battery, a silver oxide battery, a lithium battery, or a combination thereof. Multiple batteries may also be used herein. In addition, as the HHSD is hand-held, and is preferably self-contained, a battery having a high voltage to weight ratio and/or a high amperage to battery weight ratio is highly preferred, as is a light weight battery, a battery having a small volume, a highly efficient battery, etc. Typically, when fully-charged, the battery provides at least about 10 minutes, preferably at least about 30 minutes, and more preferably at least about 1 hour of continuous use, before requiring recharging and/or replacement. When not in use and/or not in a recharging stand, the battery preferably provides stand-by power for at least several hours. The battery useful herein may be removable, replaceable and/or permanent, as desired.

The electromechanical motor useful herein is known in the art, and provides a mechanical action such as lateral action, rotational action, or a combination thereof. If a lateral action is provided, then from a user-comfort, battery-usage, and design standpoint, it is preferred that the electromechanical motor provide the scrubbing surface with a lateral frequency of from about 0.5 hertz (hz) to about 300 hz, preferably from about 1 hz to about 100 hz, and more preferably from about 1 hz to about 40 hz. Similarly, if a rotational action is provided, then it is preferred that the electromechanical motor provide the scrubbing surface with a rotational frequency of from about 0.5 revolution per second (rps) to about 200 rps, preferably from about 1 rps to about 100 rps, and more preferably from about 1 rps to about 50 rps. Furthermore, if a rotational action is provided, then it is preferred that the electromechanical motor herein provide a high torque, so as to provide a rotational action, even when the scrubbing surface is strongly pressed against the item to be cleaned. This may further provide significant cleaning, noise reduction, vibration reduction, and/or noise character advantages.

In FIG. 2, an optional heating element, 52, is provided on the exterior area, 22, of the waterproof casing, 20. The heating element herein provides localized heat to the item to be cleaned, via the scrubbing surface. This may help to solubilize and/or melt certain soils, such as oils and fats, and/or may help increase bleaching effectiveness, enzyme effectiveness, etc. The heating element may have a separate activator (not shown), or may be automatic, as desired. For example, when the electromechanical motor is activated, an electrical heating element may be automatically activated as part of the same circuit. Alternatively, the heating element may be a non-electrical heating element, for example, a chemical heating element impregnated in the scrubbing surface, which employs a chemical which creates heat through an exothermic reaction when contacted with water.

In a preferred embodiment, the HHSD has a plurality of pre-programmed and/or updateable cleaning options which coordinate various factors such as type of soil/dirt, type of item to be cleaned, recommended chemistry, recommended electromechanical motor speed, recommended heating element temperature, recommended scrubbing surface, etc., and provides this recommendation to the user, via, for example, a series of lights, or a liquid crystal display screen. The user may then be able to select a particular cleaning option by pressing a button, adjusting a dial-type selector on the HHSD, etc. In a preferred embodiment, the recharging stand includes a display, such as a liquid crystal display, thereupon, which provides selections, and/or instructions to the HHSD regarding the cleaning option selected, via, for example, a data port, preferably a wireless data port such as a radio transmitter or an infrared data port. In a highly preferred embodiment, the HHSD contains a microprocessor therein which controls the various cleaning options' parameters (e.g., heating element temperature, motor speed, etc.), and automatically senses the type of scrubbing surface attached, the type of cleaning composition therein, etc. to help the user select the most appropriate cleaning option. Thus, the microprocessor, and/or the controlling software may be updateable via, for example, a personal computer, or the internet, so as to take advantage of new cleaning compositions, new scrubbing surfaces, new cleaning options, etc.

In a preferred embodiment, the HHSD also assists in drying the item to be cleaned, by, for example, providing air flow, a drying composition, heat, etc. Such a feature may, for example, significantly reduce water spots on glasses, allow the user to quickly finish the entire dishwashing process, etc.

In a highly preferred embodiment, the battery efficiency, size and weight of the device, and longevity of battery life, is optimized via the use of smart power management technology based on the use of microintegrated circuits to regulate power flow, amperage, etc. Examples of preferred smart power management technologies useful herein are disclosed in U.S. Pat. No. 6,074,775 to Gartstein and Nebrigic, granted on Jun. 13, 2000; and U.S. Pat. No. 6,118,248 to Gartstein and Nebrigic, granted on Sep. 12, 2000.

Method of Use

The present invention is used by providing a HHSD as described, providing a scrubbing surface impregnated with a cleaning composition, and contacting the item to be cleaned with the scrubbing surface, so as to clean the item. Typically, the item to be cleaned will also be contacted with water, either before, during, or after the HHSD is contacted to the item. Furthermore, the item may optionally be rinsed with water after the cleaning composition has contacted the item, or the scrubbing surface may be contacted with water prior to contacting the item to be cleaned. Preferably, the item to be cleaned is a hard surface, such as a dish, a pot, a pan, tableware, a bathroom or kitchen tile, glass, flooring, etc., and more preferably a dish, a pot, a pan, tableware, and a combination thereof.

Typically, as the scrubbing surface is impregnated with the cleaning composition, and as the scrubbing surface is used to scrub the item to be cleaned, this efficiently directs the cleaning composition to the location where it is needed, and where it will have the greatest benefit. If multiple scrubbing surfaces, multiple cleaning compositions, etc. are employed, then the method of use herein may further include the step of selecting the appropriate scrubbing surface, selecting the appropriate cleaning composition, selecting the appropriate cleaning option, etc.

Examples of the invention are set forth hereinafter by way of illustration and are not intended to be in any way limiting of the invention.

### EXAMPLE 1

A HHSD as shown in FIG. 1 is provided, which is intended to be held in a consumer's right hand while washing dishes. The HHSD's vibration buffer, and pivoting portion allows a user to easily use the HHSD for an extended period of time, such as 30 minutes, without tiring. When the rechargeable battery is fully charged, it provides up to 1 hour of continuous use. The battery is rechargeable by inserting the base of the waterproof casing into an induction-type recharging stand. The electromechanical motor provides the scrubbing surface with a lateral (side-to-side) scrubbing motion, at a variable rate of from 5 hz to 75 hz. The motor activator is a variable-speed activator. Thus, the harder it pressed, the more quickly the electromechanical motor moves the scrubbing surface.

The scrubbing surface is joined to the exterior area, which is in turn joined to the electromechanical motor. The scrubbing surface is made of porous foam rubber which is covered by a plastic, mildly abrasive surface. A hard surface cleaning composition is impregnated in the scrubbing surface, which is dry to the touch, prior to use. The scrubbing surface is attached to the exterior area by VELCROTM fasteners, which are easily removable by a user, and yet provide good adhesion when the HHSD is in use.

The HHSD is sold together with a ten scrubbing surfaces of varying textures, and contain varying dishwashing compositions for oily soils on pots and pans, bleaching and cleaning compositions for dishes, gentle scrubbing surfaces for glassware, etc. The dishwashing detergent compositions generally contain an anionic surfactant, an oxygen bleach, minor ingredients, and a carrier system.

The scrubbing surface is intended to be briefly dipped in water to begin solubilizing and activating the cleaning composition. The motor activator is then pressed, and the scrubbing surface begins to move back and forth. The moving scrubbing surface is then contacted to the surface of a dish, thereby cleaning the dish.

### EXAMPLE 2

A set of ten scrubbing surfaces is provided as a refill package for the HHSD of Example 1. As above, the ten scrubbing surfaces have varying textures, and contain varying dishwashing compositions for oily soils on pots and pans, bleaching and cleaning compositions for dishes, gentle scrubbing surfaces for glassware, etc. The dishwashing detergent compositions generally contain an anionic surfactant, an oxygen bleach, minor ingredients, and a carrier system.

What is claimed is:

1. A hand-held scrubbing device for cleaning a surface, the hand-held scrubbing device comprising a waterproof casing comprising:
A. an interior area comprising:
i. an electromechanical motor; and
ii. a battery joined to the electromechanical motor; and
B. an exterior area comprising a scrubbing surface impregnated with a cleaning composition, the scrubbing surface being removably joined to the electromechanical motor,
wherein the electromechanical motor provides a mechanical action to the scrubbing surface.

2. The hand-held scrubbing device of claim 1, wherein the battery is a rechargeable battery, wherein at least a portion of the waterproof casing removably rests in a recharging stand when not in use, and wherein when removably resting in the recharging stand, the rechargeable battery is recharged.

3. The hand-held scrubbing device of claim 1, further comprising a pivoting portion, the scrubbing surface being joined to the pivoting portion.

4. The hand-held scrubbing device of claim 1, wherein the waterproof casing further comprises a faucet connection, and a rinsing orifice joined to the faucet connection.

5. A method for cleaning an item comprising the steps of:
A. providing the hand-held scrubbing device of claim 1; and
B. contacting the item with the scrubbing surface so as to clean the item.

6. The method of claim 5, wherein the item is a hard surface item.

7. A kit for providing improved cleaning comprising:
A. hand-held scrubbing device for cleaning a surface, the hand-held scrubbing device comprising a waterproof casing comprising:
i. an interior area comprising:
a. an electromechanical motor; and
b. a battery joined to the electromechanical motor; and
ii. an exterior area,
wherein the electromechanical motor provides a mechanical action to the scrubbing surface; and
B. a scrubbing surface impregnated with a cleaning composition, the scrubbing surface being designed to be removably joined to the electromechanical motor.

8. The kit of claim 7, wherein the cleaning composition is a hard surface cleaning composition.

9. A disposable scrubbing surface impregnated with a cleaning composition, wherein the disposable scrubbing surface may be removably joined to a hand-held scrubbing device.

10. The disposable scrubbing surface of claim 9, wherein the hand-held scrubbing device comprises an electromechanical motor which provides a mechanical action to the disposable scrubbing surface.
